(19) United States
(12) Patent Application Publication
(10) Pub. No.: US 2025/0233344 A1
(43) Pub. Date: Jul. 17, 2025

(54) ELECTRICAL CONNECTOR

(71) Applicant: CHENG UEI PRECISION INDUSTRY CO., LTD., New Taipei City (TW)

(72) Inventors: ZE-LE HU, Dong-Guan City (CN); YU-JIE WU, Dong-Guan City (CN); YUN WU, Dong-Guan City (CN)

(21) Appl. No.: 18/805,500

(22) Filed: Aug. 14, 2024

(30) Foreign Application Priority Data
Jan. 16, 2024 (CN) 202420112286.1

(51) Int. Cl. H01R 13/502; H01R 13/405; H01R 13/6585

(52) U.S. Cl. CPC H01R 13/502; H01R 13/405; H01R 13/6585

(57) ABSTRACT

An electrical connector includes an insulating housing, an insulation body, an upper terminal assembly and a lower terminal assembly. The insulating housing has a plurality of fastening blocks and a plurality of fastening slots. Several portions of a lower end of a rear surface of the insulating housing extend rearward to form the plurality of the fastening blocks. Each fastening slot is formed between two adjacent fastening blocks. The insulation body is fastened in the insulating housing. The upper terminal assembly is fastened in an upper portion of the insulation body. The lower terminal assembly is fastened in a lower portion of the insulation body. The upper terminal assembly and the lower terminal assembly are disposed opposite to each other.

### CROSS REFERENCE TO RELATED APPLICATIONS

The present application is based on, and claims priority from, China Patent Application No. 202420112286.1, filed Jan. 16, 2024, the disclosure of which is hereby incorporated by reference herein in its entirety.

### BACKGROUND OF THE INVENTION

### Field of the Invention

The present invention generally relates to an electrical connector, and more particularly to an electrical connector having an insulating housing without a burr, a higher assembling accuracy of a soldering portion of a terminal and a stable size of the terminal, and preventing a short shot problem of the insulating housing.

### Description of Related Art

In various electrical connector types which are frequently used by various electronic products, universal serial bus (USB) connectors are the most widely applied connectors. With the improvement of sciences and technologies, more and more kinds of the universal serial bus connectors are developed, such as USB 2.0 connectors, USB 3.0 connectors, Micro USB connectors, Mini USB connectors or USB Type-C connectors. The USB Type-C connectors have been widely applied in the various electronic products.

A conventional electrical connector includes an insulation body and a plurality of conductive terminals. The insulation body has a base portion and a docking portion. A top surface of the base portion extends upward to form the docking portion. The docking portion has an inserting groove penetrating through a middle of a top surface of the docking portion. The insulation body has a plurality of terminal slots penetrating through a top surface of one side wall of the inserting groove and a bottom surface of the base portion. Each conductive terminal has a fastening portion, a contacting portion, a connecting portion and a soldering portion. The fastening portions of the plurality of the conductive terminals are fastened in the plurality of the terminal slots. A top end of the fastening portion extends upward to form the contacting portion. A bottom end of the fastening portion extends downward to form the connecting portion. A bottom end of the connecting portion is bent sideward to form the soldering portion. A rear of a bottom end of the base portion is recessed inward to form an accommodating cavity. A side wall of the accommodating cavity has a retaining block projecting into the accommodating cavity. The retaining block defines a plurality of fastening slots penetrating through a top surface and a bottom surface of the retaining block. The plurality of the fastening slots are corresponding to the plurality of the terminal slots. The connecting portions of the plurality of the conductive terminals are fastened in the plurality of the fastening slots. The retaining block has a plurality of retaining walls formed among the plurality of the fastening slots. A bottom end of each retaining wall has two inclined guiding surfaces. The two inclined guiding surfaces are inclined downward and inward, and two bottoms of the two inclined guiding surfaces are connected to form a tip.

However, the soldering portions of the plurality of the conductive terminals of the conventional electrical connector are suspended in the accommodating cavity of the insulation body, in a process of manufacturing the electrical connector, the plurality of the conductive terminals are easily deformed, and sizes of the plurality of the conductive terminals are affected. The tip of each retaining wall of the retaining block easily protrudes a burr in an injection molding process, and a shape design of the tip of each retaining wall of the retaining block easily causes a short shot problem of the insulation body.

Thus, it is essential to provide an innovative electrical connector. The innovative electrical connector has an insulating housing without a burr, a higher assembling accuracy of a soldering portion of a terminal and a stable size of the terminal, and prevents a short shot problem of the insulating housing.

### BRIEF SUMMARY OF THE INVENTION

An object of the present invention is to provide an electrical connector having an insulating housing without a burr, a higher assembling accuracy of a soldering portion of a terminal and a stable size of the terminal, and preventing a short shot problem of the insulating housing. The electrical connector includes an insulating housing, an insulation body, an upper terminal assembly and a lower terminal assembly. The insulating housing has a plurality of fastening blocks and a plurality of fastening slots. Several portions of a lower end of a rear surface of the insulating housing extend rearward to form the plurality of the fastening blocks. Each fastening slot is formed between two adjacent fastening blocks. Each fastening block has two connecting surfaces, two inclining surfaces and a protecting plane. Two fronts of two opposite sides of each fastening block extend rearward to form the two connecting surfaces. The connecting surfaces of the plurality of the fastening blocks are connected to the plurality of the fastening slots. Rear ends of the two connecting surfaces of each fastening block slantwise extend rearward and inward to form the two inclining surfaces. The protecting plane is connected between two rear ends of the two inclining surfaces. The insulation body is fastened in the insulating housing. The upper terminal assembly is fastened in an upper portion of the insulation body. The upper terminal assembly includes a plurality of upper terminals and an upper base portion. The plurality of the upper terminals are fastened in the upper base portion. Each upper terminal has an upper fastening portion. A front end of the upper fastening portion extends frontward to form an upper contacting portion. A rear end of the upper fastening portion is bent downward to form an upper bending portion. A bottom end of the upper bending portion extends downward to form an upper extending portion. A bottom end of the upper extending portion is bent rearward to form an upper soldering portion. A rear end of the upper base portion extends downward to form a surrounding portion. Several portions of a top end and a bottom end of the surrounding portion vertically protrude outward to form a plurality of protruding portions. The upper contacting portions of the plurality of the upper terminals are exposed to a top surface of a front end of the upper base portion. The upper extending portions of the plurality of the upper terminals are fastened in the surrounding portion, and the upper extending portions of the plurality of the upper terminals are surrounded by the surrounding portion. The plurality of the protruding portions cover outer surfaces of the upper extending portions and the upper soldering portions of the plurality of the upper terminals. The lower terminal assembly is fastened in a lower portion of the insulation body. The upper terminal assembly and the lower terminal assembly are disposed opposite to each other. The lower terminal assembly includes a plurality of lower terminals and a lower base portion. The plurality of the lower terminals are fastened in the lower base portion. Each lower terminal is disposed between the two adjacent fastening blocks. Each lower terminal has a lower fastening portion. A front end of the lower fastening portion extends frontward to form a lower contacting portion. A rear end of the lower fastening portion is bent downward to form a lower bending portion. A bottom end of the lower bending portion extends downward to form a lower extending portion. A bottom end of the lower extending portion is bent frontward to form a reflecting portion. A front end of the reflecting portion extends frontward to form a lower soldering portion. The lower contacting portions of the plurality of the lower terminals are exposed to a bottom surface of a front end of the lower base portion. The inclining surfaces of the plurality of the fastening blocks guide the bottom ends of the lower extending portions of the plurality of the lower terminals to be positioned in the plurality of the fastening slots. The bottom end of the lower extending portion of each lower terminal is buckled between the two connecting surfaces of the two adjacent fastening blocks. The inclining surfaces of the plurality of the fastening blocks guide the lower soldering portions and the reflecting portions of the plurality of the lower terminals to be located to bottoms of the connecting surfaces of the plurality of the fastening blocks of the insulating housing.

Another object of the present invention is to provide an electrical connector. The electrical connector includes an insulating housing, an insulation body fastened in the insulating housing, and a terminal assembly. The insulating housing has a plurality of fastening blocks and a plurality of fastening slots. Several portions of a lower end of a rear surface of the insulating housing extend rearward to form the plurality of the fastening blocks. Each fastening slot is formed between two adjacent fastening blocks. Each fastening block has two connecting surfaces, two inclining surfaces and a protecting plane. Two fronts of two opposite sides of each fastening block extend rearward to form the two connecting surfaces. The connecting surfaces of the plurality of the fastening blocks are connected to the plurality of the fastening slots. Rear ends of the two connecting surfaces of each fastening block slantwise extend rearward and inward to form the two inclining surfaces. The protecting plane is connected between two rear ends of the two inclining surfaces. The terminal assembly is fastened in the insulation body. The insulation body together with the terminal assembly is received in the insulating housing. The terminal assembly includes a base portion, and a plurality of terminals fastened in the base portion. Each terminal has a fastening portion. A front end of the fastening portion extends frontward to form a contacting portion. A rear end of the fastening portion is bent downward to form a bending portion. A bottom end of the bending portion extends downward to form an extending portion. A bottom end of the extending portion is bent longitudinally and extends longitudinally to form a soldering portion. The base portion has a main body. A rear end of the main body extends downward to form a surrounding portion. The extending portions of the plurality of the terminals are fastened in the surrounding portion, and the extending portions of the plurality of the terminals are surrounded by the surrounding portion. The extending portions of the plurality of the terminals are longitudinally arranged in a front row and a rear row. The soldering portions of the plurality of the terminals project beyond a bottom surface of the surrounding portion. An outer surface of a junction between the rear end of the main body and a top end of the surrounding portion is recessed inward to form a fastening groove. The bending portions of the plurality of the terminals are exposed out of the base portion from the fastening groove. The contacting portions of the plurality of the terminals are exposed to an outer surface of a front end of the base portion. The inclining surfaces and the protecting planes of the plurality of the fastening blocks guide the bottom ends of the extending portions of the plurality of the terminals which are arranged in the front row to be positioned in the plurality of the fastening slots. The bottom end of the extending portion of each terminal is buckled between the two connecting surfaces of the two adjacent fastening blocks. The inclining surfaces and the protecting planes of the plurality of the fastening blocks guide the soldering portions of the plurality of the terminals to be located to bottoms of the connecting surfaces of the plurality of the fastening blocks of the insulating housing.

Another object of the present invention is to provide an electrical connector. The electrical connector includes an insulating housing, an insulation body fastened in the insulating housing, an upper terminal assembly and a lower terminal assembly. The insulating housing has a plurality of fastening slots. Several portions of a lower end of a rear surface of the insulating housing extends rearward to form a plurality of fastening blocks. Each fastening slot is formed between two adjacent fastening blocks. Each fastening block has two connecting surfaces, two inclining surfaces, a protecting plane and two rounded corners. Two fronts of two opposite sides of each fastening block extend rearward to form the two connecting surfaces. The connecting surfaces of the plurality of the fastening blocks are connected to the plurality of the fastening slots. Rear ends of the two connecting surfaces of each fastening block slantwise extend rearward and inward to form the two inclining surfaces. The protecting plane is connected between two rear ends of the two inclining surfaces. Each rounded corner is formed between one inclining surface and one side of the protecting plane. The upper terminal assembly is fastened in an upper portion of the insulation body. The upper terminal assembly includes a plurality of upper terminals and an upper base portion. The plurality of the upper terminals are fastened in the upper base portion. Each upper terminal has an upper fastening portion. A front end of the upper fastening portion extends frontward to form an upper contacting portion. A rear end of the upper fastening portion is bent downward to form an upper bending portion. A bottom end of the upper bending portion extends downward to form an upper extending portion. A bottom end of the upper extending portion is bent rearward to form an upper soldering portion. A rear end of the upper base portion extends downward to form a surrounding portion. Several portions of a top end and a bottom end of the surrounding portion vertically protrude outward to form a plurality of protruding portions. The upper contacting portions of the plurality of the upper terminals are exposed to a top surface of a front end of the upper base portion. The upper extending portions of the plurality of the upper terminals are fastened in the surrounding portion. The plurality of the protruding portions cover outer surfaces of the upper extending portions and the upper soldering portions of the plurality of the upper terminals. The lower terminal assembly is fastened in a lower portion of the insulation body. The upper terminal assembly and the lower terminal assembly are disposed opposite to each other. The lower terminal assembly includes a plurality of lower terminals and a lower base portion. The plurality of the lower terminals are fastened in the lower base portion. Each lower terminal is disposed between the two adjacent fastening blocks. Each lower terminal has a lower fastening portion. A front end of the lower fastening portion extends frontward to form a lower contacting portion. A rear end of the lower fastening portion is bent downward to form a lower bending portion. A bottom end of the lower bending portion extends downward to form a lower extending portion. A bottom end of the lower extending portion is bent frontward to form a reflecting portion. A front end of the reflecting portion extends frontward to form a lower soldering portion. The lower contacting portions of the plurality of the lower terminals are exposed to a bottom surface of a front end of the lower base portion. The inclining surfaces of the plurality of the fastening blocks guide the bottom ends of the lower extending portions of the plurality of the lower terminals to be positioned in the plurality of the fastening slots. The bottom end of the lower extending portion of each lower terminal is buckled between the two connecting surfaces of the two adjacent fastening blocks. The inclining surfaces of the plurality of the fastening blocks guide the lower soldering portions and the reflecting portions of the plurality of the lower terminals to be located to bottoms of the connecting surfaces of the plurality of the fastening blocks of the insulating housing.

As described above, the electrical connector has an innovative structure design, the upper bending portions of the plurality of the upper terminals are exposed out of the upper base portion from the fastening groove of the upper base portion. When the upper base portion is molded to the plurality of the upper terminals, and the insulation body is molded to the upper terminal assembly in a high speed injection molding process, the fastening groove of the upper base portion prevents the plurality of the upper terminals from causing a deformation and a displacement of the plurality of the upper terminals. The plurality of the protruding portions of the upper base portion cover the outer surfaces of the upper extending portions and the upper soldering portions of the plurality of the upper terminals, so that a size stability of the plurality of the upper terminals and an assembling accuracy of the plurality of the upper terminals are ensured. Furthermore, the rear ends of the two connecting surfaces of each fastening block slantwise extend rearward and inward to form the two inclining surfaces, the protecting plane is connected between the two rear ends of the two inclining surfaces, so the protecting planes of the plurality of the fastening blocks are used for shaping the plurality of the fastening blocks easily to prevent causing a burr of each fastening block, and the protecting plane is used for preventing a short shot problem of the insulating housing. In addition, the lower extending portions and the lower soldering portions of the plurality of the lower terminals are inclined frontward, each lower terminal is preloaded, when the lower terminal assembly is assembled with the insulating housing, the bottom ends of the lower extending portions of the plurality of the lower terminals are easily inserted into the plurality of the fastening slots of the insulating housing, and the lower soldering portions and the reflecting portions of the plurality of the lower terminals are easily exposed to bottoms of the plurality of the fastening slots for improving the assembling accuracy of the plurality of the upper terminals. As a result, the electrical connector has the insulating housing without the burr, a higher assembling accuracy of the soldering portion of the terminal and a stable size of the terminal, and prevents a short shot problem of the insulating housing.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with the present invention;

FIG. 2 is another perspective view of the electrical connector of FIG. 1;

FIG. 3 is a partially exploded view showing a glue body, an insulating housing, a metal shell assembly, and an insulation body together with a terminal assembly, a middle grounding plate and two shielding plates of the electrical connector of FIG. 1;

FIG. 4 is another partially exploded view showing the insulation body, the two shielding plates, and the terminal assembly together with the middle grounding plate of the electrical connector of FIG. 1;

FIG. 5 is a perspective view of an upper terminal assembly of the electrical connector of FIG. 1;

FIG. 6 is an exploded view of the upper terminal assembly of the electrical connector of FIG. 5;

FIG. 7 is an exploded view of a lower terminal assembly of the electrical connector of FIG. 2;

FIG. 8 is a perspective view of the insulating housing of the electrical connector of FIG. 2;

FIG. 9 is an enlarged view of an encircled portion IX of the electrical connector of FIG. 8; and

FIG. 10 is an enlarged view of an encircled portion X of the electrical connector of FIG. 2.

### DETAILED DESCRIPTION OF THE INVENTION

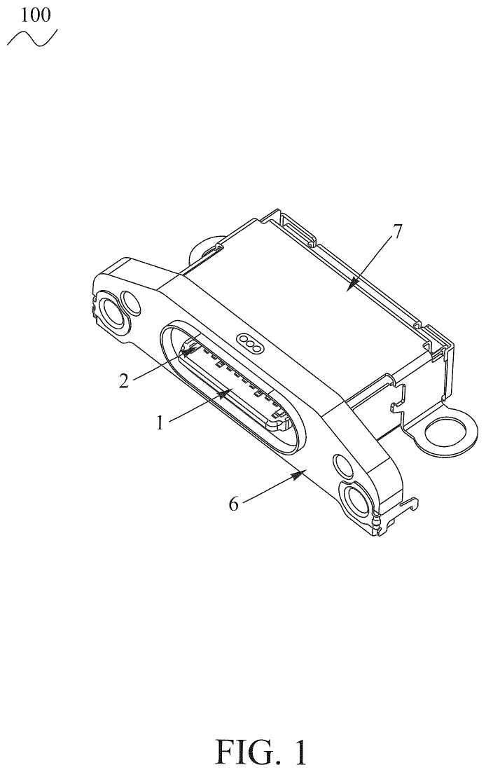

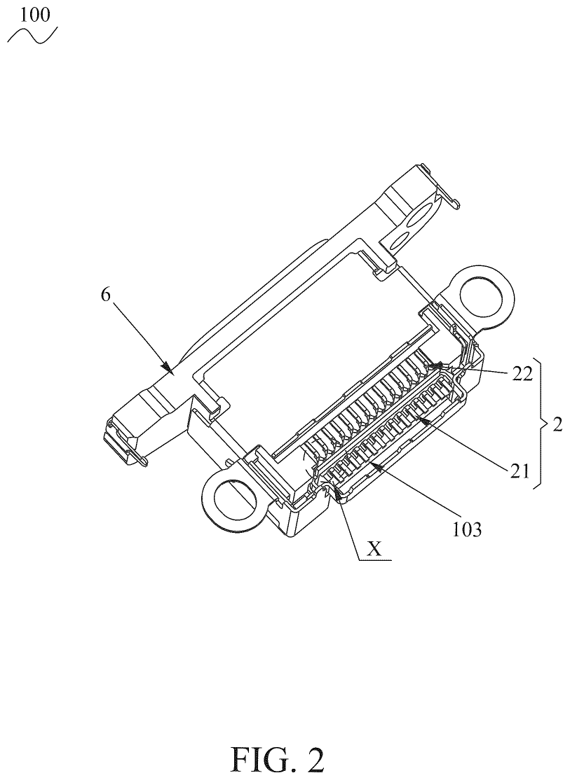

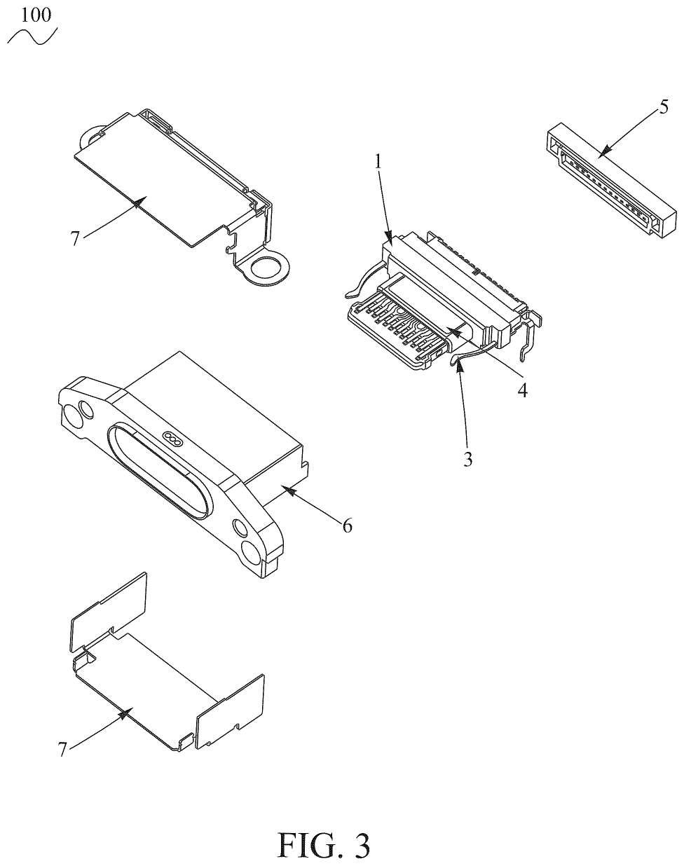

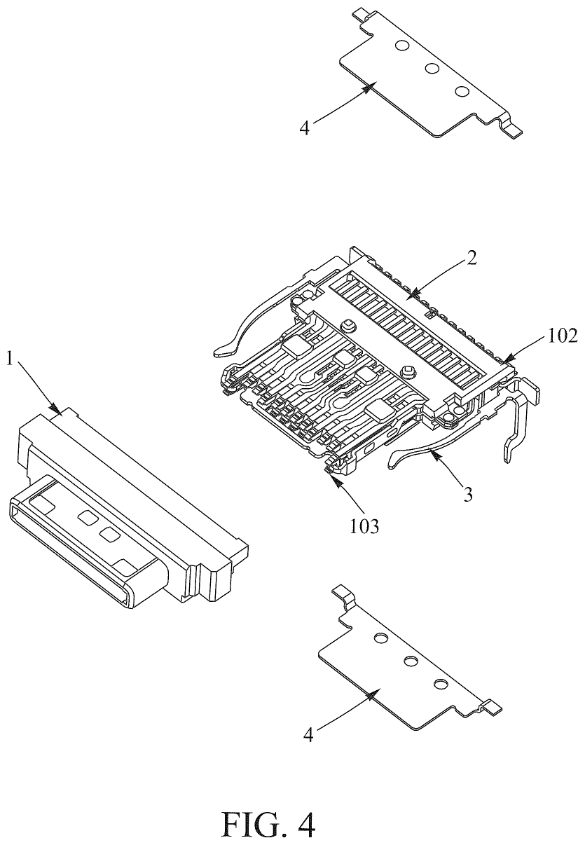

With reference to FIG. 1 to FIG. 4, an electrical connector 100 in accordance with the present invention is shown. The electrical connector 100 includes an insulation body 1, a terminal assembly 2, a middle grounding plate 3, two shielding plates 4, a glue body 5, an insulating housing 6 and a metal shell assembly 7. In the present invention, the electrical connector 100 is a USB (Universal Serial Bus) Type-C connector. In a concrete implementation, the electrical connector 100 is able to be another type connector which has a smaller pitch between two adjacent terminals 103.

The terminal assembly 2 is fastened in the insulation body 1. The middle grounding plate 3 is mounted in a middle of the terminal assembly 2, and the terminal assembly 2 and the middle grounding plate 3 are fastened in the insulation body 1. The insulation body 1 surrounds the middle grounding plate 3 and the terminal assembly 2. The two shielding plates 4 are disposed to an upper surface and a lower surface of the insulation body 1. The insulation body 1 is fastened in the insulating housing 6. The metal shell assembly 7 is disposed to an upper surface and a lower surface of the insulating housing 6. The metal shell assembly 7 is used for being connected to ground and shielding an interference.

The glue body 5 surrounds a rear end of the insulation body 1. The glue body 5 is covered to a rear end of the insulating housing 6. The glue body 5 seals up a gap among the insulation body 1, the terminal assembly 2, the middle grounding plate 3, the two shielding plates 4 and the insulating housing 6, so that water is prevented from flowing into a rear end of the electrical connector 100, and the electrical connector 100 is prevented from being damaged due to a water immersion condition of the electrical connector 100. The glue body 5 surrounds a part of the terminal assembly 2 and a part of the middle grounding plate 3.

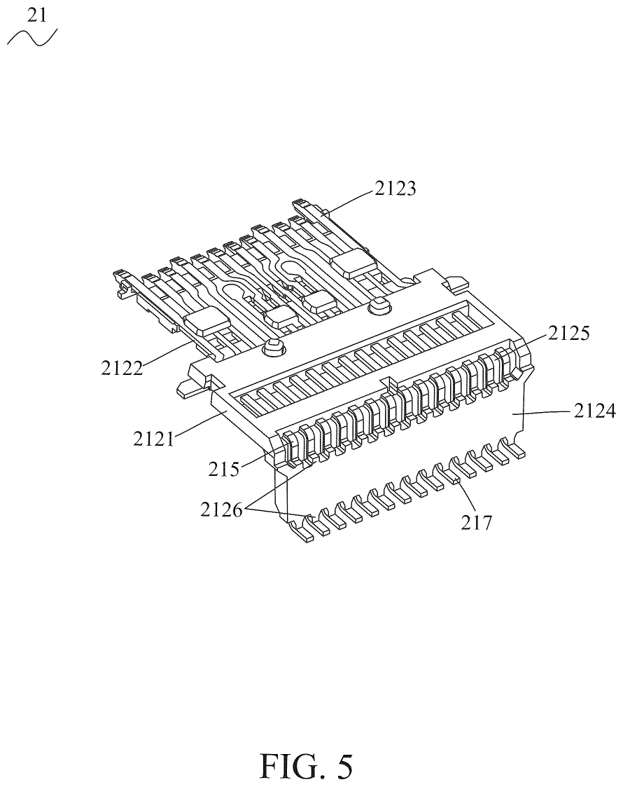

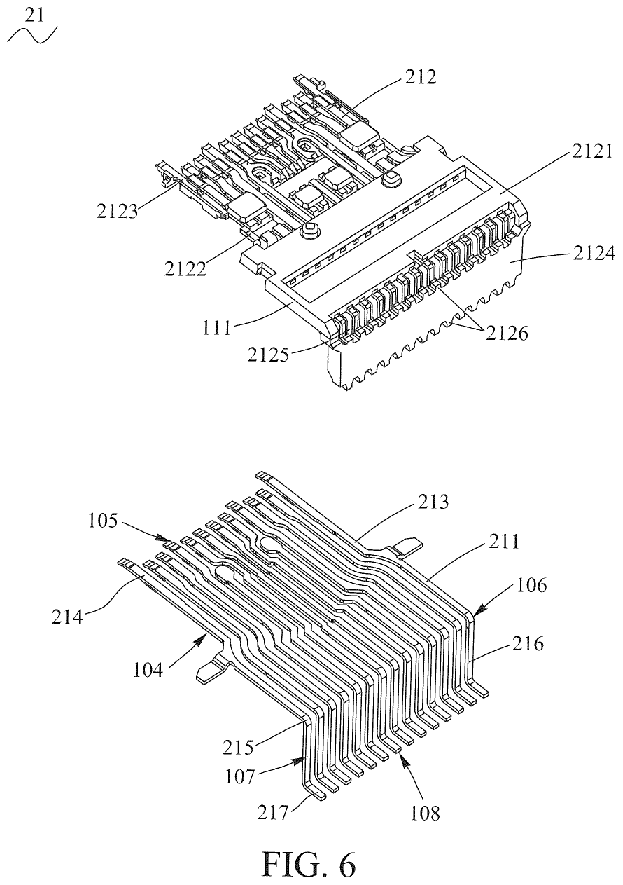

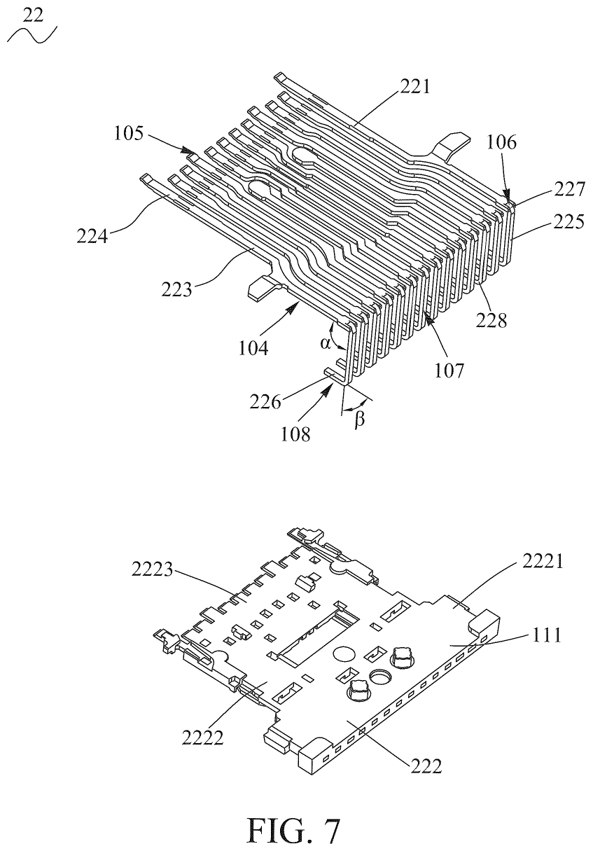

Referring to FIG. 5 to FIG. 7, the terminal assembly 2 is disposed in the insulation body 1. The terminal assembly 2 includes an upper terminal assembly 21 fastened in an upper portion of the insulation body 1, and a lower terminal assembly 22 fastened in a lower portion of the insulation body 1. The upper terminal assembly 21 is disposed on a top surface of the middle grounding plate 3. The lower terminal assembly 22 is disposed under a bottom surface of the middle grounding plate 3. The lower terminal assembly 22 is located under the upper terminal assembly 21. The upper terminal assembly 21 and the lower terminal assembly 22 are disposed opposite to each other. The middle grounding plate 3 is disposed between the upper terminal assembly 21 and the lower terminal assembly 22. The upper terminal assembly 21 includes a plurality of upper terminals 211 and an upper base portion 212. The plurality of the upper terminals 211 are fastened in the upper base portion 212.

Each upper terminal 211 has an upper fastening portion 213, an upper contacting portion 214, an upper bending portion 215, an upper extending portion 216 and an upper soldering portion 217. A front end of the upper fastening portion 213 extends frontward to form the upper contacting portion 214. A rear end of the upper fastening portion 213 is bent downward to form the upper bending portion 215. A bottom end of the upper bending portion 215 extends downward to form the upper extending portion 216. A bottom end of the upper extending portion 216 is bent rearward to form the upper soldering portion 217.

The upper base portion 212 has an upper main body 2121, an upper connecting portion 2122, an upper tongue portion 2123, a surrounding portion 2124 and a fastening groove 2125. A rear end of the upper base portion 212 extends downward to form the surrounding portion 2124. A middle of a front end of the upper main body 2121 extends frontward to form the upper connecting portion 2122. A front end of the upper connecting portion 2122 extends frontward to form the upper tongue portion 2123. A rear end of the upper main body 2121 extends downward to form the surrounding portion 2124. An outer surface of a junction between the rear end of the upper main body 2121 and a top end of the surrounding portion 2124 of the upper base portion 212 is recessed inward to form the fastening groove 2125. Several portions of the top end and a bottom end of the surrounding portion 2124 vertically protrude outward to form a plurality of protruding portions 2126.

The upper fastening portions 213 of the plurality of the upper terminals 211 are fastened in the upper main body 2121 and the upper connecting portion 2122 of the upper base portion 212, and the upper fastening portions 213 of the plurality of the upper terminals 211 are partially surrounded by the upper main body 2121 and the upper connecting portion 2122 of the upper base portion 212. Top surfaces of the upper fastening portions 213 of the plurality of the upper terminals 211 are partially exposed to top surfaces of the upper main body 2121 and the upper connecting portion 2122. The upper contacting portions 214 of the plurality of the upper terminals 211 are exposed to a top surface of a front end of the upper base portion 212. The upper contacting portions 214 of the plurality of the upper terminals 211 are fastened in the upper tongue portion 2123 of the upper base portion 212, and the upper contacting portions 214 of the plurality of the upper terminals 211 are partially surrounded by the upper tongue portion 2123 of the upper base portion 212. Top surfaces of the upper contacting portions 214 of the plurality of the upper terminals 211 are exposed to a top surface of the upper tongue portion 2123. The upper extending portions 216 of the plurality of the upper terminals 211 are fastened in the surrounding portion 2124 of the upper base portion 212, and the upper extending portions 216 of the plurality of the upper terminals 211 are surrounded by the surrounding portion 2124 of the upper base portion 212. The upper soldering portions 217 of the plurality of the upper terminals 211 project beyond a bottom surface of the surrounding portion 2124 of the upper base portion 212. Outer surfaces of the upper bending portions 215 of the plurality of the upper terminals 211 are exposed out of the upper base portion 212 from the fastening groove 2125 of the upper base portion 212.

When the upper base portion 212 is molded to the plurality of the upper terminals 211, and the insulation body 1 is molded to the upper terminal assembly 21 in a high speed injection molding process, the fastening groove 2125 of the upper base portion 212 prevents the plurality of the upper terminals 211 from causing a deformation and a displacement of the plurality of the upper terminals 211. The plurality of the protruding portions 2126 of the upper base portion 212 cover outer surfaces of the upper extending portions 216 and the upper soldering portions 217 of the plurality of the upper terminals 211. When the plurality of the upper terminals 211 are electroplated, transported and assembled, the plurality of the protruding portions 2126 of the upper base portion 212 prevent the plurality of the upper terminals 211 from being deformed, so that a size stability of the plurality of the upper terminals 211 and an assembling accuracy of the plurality of the upper terminals 211 are ensured.

The lower terminal assembly 22 includes a plurality of lower terminals 221 and a lower base portion 222. The plurality of the lower terminals 221 are fastened in the lower base portion 222. Each lower terminal 221 has a lower fastening portion 223, a lower contacting portion 224, a lower bending portion 227, a lower extending portion 225, a reflecting portion 228 and a lower soldering portion 226. A front end of the lower fastening portion 223 extends frontward to form the lower contacting portion 224. A rear end of the lower fastening portion 223 is bent downward to form the lower bending portion 227. A bottom end of the lower bending portion 227 extends downward to form the lower extending portion 225. A bottom end of the lower extending portion 225 is bent frontward to form the reflecting portion 228. A front end of the reflecting portion 228 extends frontward to form the lower soldering portion 226. The lower extending portions 225 of the plurality of the lower terminals 221 are corresponding to the upper extending portions 216 of the plurality of the upper terminals 211. The lower soldering portions 226 of the plurality of the lower terminals 221 are corresponding to the upper soldering portions 217 of the plurality of the upper terminals 211. An extending direction of the lower soldering portion 226 is opposite to an extending direction of the upper soldering portion 217 of each upper terminal 211.

The lower base portion 222 has a lower main body 2221, a lower connecting portion 2222 and a lower tongue portion 2223. A middle of a front end of the lower main body 2221 extends frontward to form the lower connecting portion 2222. A front end of the lower connecting portion 2222 extends frontward to the lower tongue portion 2223. The lower fastening portions 223 of the plurality of the lower terminals 221 are fastened in the lower main body 2221 and the lower connecting portion 2222 of the lower base portion 222, and the lower fastening portions 223 of the plurality of the lower terminals 221 are partially surrounded by the lower main body 2221 and the lower connecting portion 2222 of the lower base portion 222. Bottom surfaces of the lower fastening portions 223 of the plurality of the lower terminals 221 are exposed to bottom surfaces of the lower main body 2221 and the lower connecting portion 2222 of the lower base portion 222. The lower contacting portions 224 of the plurality of the lower terminals 221 are exposed to a bottom surface of a front end of the lower base portion 222. The lower contacting portions 224 of the plurality of the lower terminals 221 are fastened in the lower tongue portion 2223 of the lower base portion 222, and the lower contacting portions 224 of the plurality of the lower terminals 221 are partially surrounded by the lower tongue portion 2223 of the lower base portion 222. Bottom surfaces of the lower contacting portions 224 of the plurality of the lower terminals 221 are exposed to a bottom surface of the lower tongue portion 2223 of the lower base portion 222. The lower bending portions 227, the reflecting portions 228 and the lower soldering portions 226 of the plurality of the lower terminals 221 project beyond a rear surface of the lower main body 2221 of the lower base portion 222.

In the concrete implementation, a rear end of the lower main body 2221 extends downward to form the surrounding portion 2124 of the lower base portion 222. Several portions of the top end and the bottom end of the surrounding portion 2124 of the lower base portion 222 vertically protrude outward to form the plurality of the protruding portions 2126 of the lower base portion 222. The lower extending portions 225 of the plurality of the lower terminals 221 are fastened in the surrounding portion 2124 of the lower base portion 222, and the lower extending portions 225 of the plurality of the lower terminals 221 are surrounded by the surrounding portion 2124 of the lower base portion 222. The lower soldering portions 226 of the plurality of the lower terminals 221 project beyond the bottom surface of the surrounding portion 2124 of the lower base portion 222. A junction between the rear end of the lower main body 2221 and the top end of the surrounding portion 2124 of the lower base portion 222 is recessed inward to form the fastening groove 2125 of the lower base portion 222. The lower bending portions 227 of the plurality of the lower terminals 221 are exposed out of the lower base portion 222 from the fastening groove 2125 of the lower base portion 222.

When the lower base portion 222 is molded to the plurality of the lower terminals 221, and the insulation body 1 is molded to the lower terminal assembly 22 in the high speed injection molding process, the fastening groove 2125 of the lower base portion 222 prevents the plurality of the lower terminals 221 from causing the deformation and the displacement of the plurality of the lower terminals 221. The plurality of the protruding portions 2126 of the lower base portion 222 cover outer surfaces of the lower extending portions 225 and the lower soldering portions 226 of the plurality of the lower terminals 221. When the plurality of the lower terminals 221 are electroplated, transported and assembled, the plurality of the protruding portions 2126 of the lower base portion 222 prevent the plurality of the lower terminals 221 from being deformed, so that a size stability of the plurality of the lower terminals 221 and an assembling accuracy of the plurality of the lower terminals 221 are ensured.

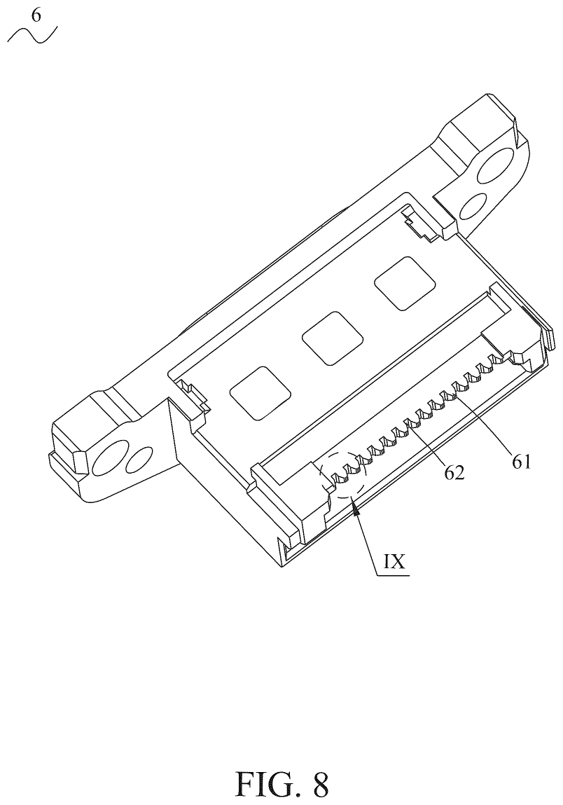

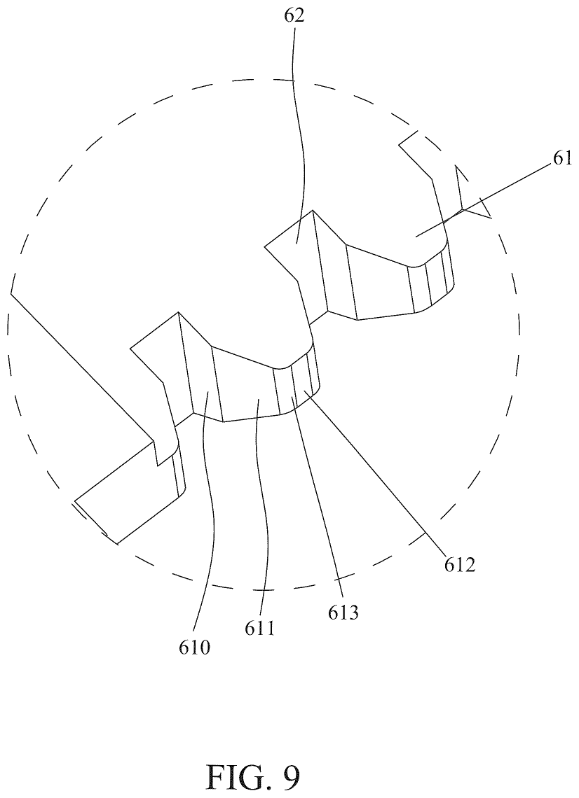

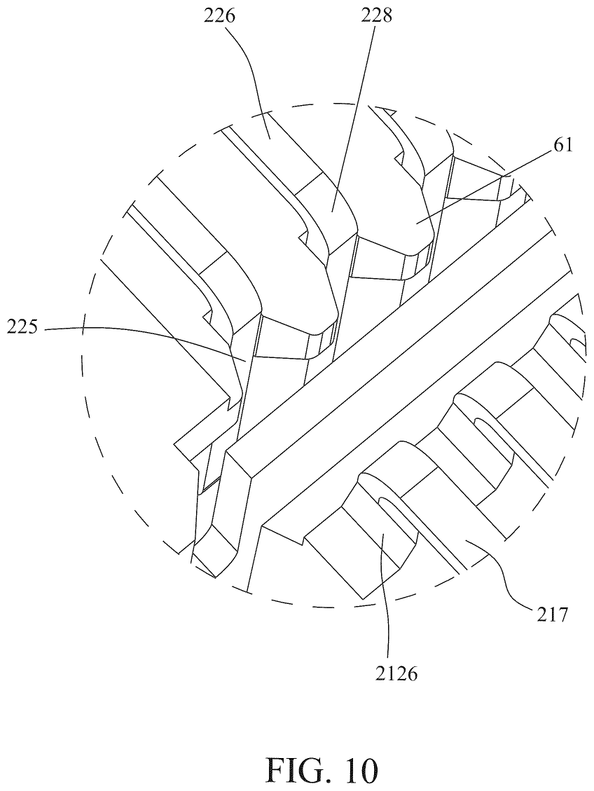

Referring to FIG. 8 to FIG. 10, the insulating housing 6 is hollow. The insulating housing 6 has a plurality of fastening blocks 61 and a plurality of fastening slots 62. Several portions of a lower end of a rear surface of the insulating housing 6 extend rearward to form the plurality of the fastening blocks 61. The plurality of the fastening blocks 61 are arranged in a comb shape. Each fastening slot 62 is formed between two adjacent fastening blocks 61. Each lower terminal 221 is disposed between the two adjacent fastening blocks 61. The bottom ends of the lower extending portions 225 of the plurality of the lower terminals 221 are fastened in the plurality of the fastening slots 62. The lower soldering portions 226 and the reflecting portions 228 of the plurality of the lower terminals 221 are exposed to bottoms of the plurality of the fastening slots 62. The plurality of the lower soldering portions 226 are located under a bottom surface of the insulating housing 6.

In the present invention, an angle α between an inner surface of the lower fastening portion 223 and an inner surface of the lower extending portion 225 which are located to two ends of the lower bending portion 227 of each lower terminal 221 is ranged from eighty-seven degrees to eighty-eight point five degrees, and an angle β between the inner surface of the lower extending portion 225 and an inner surface of the lower soldering portion 226 which are located to two ends of the lower reflecting portion 228 of each lower terminal 221 is ranged from eighty-nine degrees to ninety degrees, so the lower extending portions 225 and the lower soldering portions 226 of the plurality of the lower terminals 221 are inclined frontward. Each lower terminal 221 is preloaded. When the lower terminal assembly 22 is assembled with the insulating housing 6, the bottom ends of the lower extending portions 225 of the plurality of the lower terminals 221 are easily inserted into the plurality of the fastening slots 62 of the insulating housing 6, and the lower soldering portions 226 and the reflecting portions 228 of the plurality of the lower terminals 221 are easily exposed to the bottoms of the plurality of the fastening slots 62. When the lower terminal assembly 22 is soldered, the angle β of each lower terminal 221 prevents an empty solder of the lower soldering portion 226 of each lower terminal 221. In the concrete implementation, the angle β of each lower terminal 221 is unlimited to prevent the empty solder of the lower soldering portion 226 of each lower terminal 221.

Each fastening block 61 has two connecting surfaces 610, two inclining surfaces 611, a protecting plane 612 and two rounded corners 613. Two fronts of two opposite sides of each fastening block 61 extend rearward to form the two connecting surfaces 610. Several portions of a rear surface of a bottom wall of the insulating housing 6 extend rearward to form the connecting surfaces 610 of the plurality of the fastening blocks 61. Each fastening slot 62 is defined among the two adjacent connecting surfaces 610 and the rear surface of the bottom wall of the insulating housing 6. The connecting surfaces 610 of the plurality of the fastening blocks 61 are connected to the plurality of the fastening slots 62. The bottom end of the lower extending portion 225 of each lower terminal 221 is buckled between the two connecting surfaces 610 of the two adjacent fastening blocks 61. The bottom ends of the lower extending portions 225 of the plurality of the lower terminals 221 are buckled among the connecting surfaces 610 of the plurality of the fastening blocks 61. The lower soldering portions 226 and the reflecting portions 228 of the plurality of the lower terminals 221 are located to bottoms of the connecting surfaces 610 of the plurality of the fastening blocks 61.

Rear ends of the two connecting surfaces 610 of each fastening block 61 slantwise extend rearward and inward to form the two inclining surfaces 611. The inclining surfaces 611 of the plurality of the fastening blocks 61 guide the bottom ends of the lower extending portions 225 of the plurality of the lower terminals 221 to be positioned in the plurality of the fastening slots 62. The inclining surfaces 611 of the plurality of the fastening blocks 61 guide the lower soldering portions 226 and the reflecting portions 228 of the plurality of the lower terminals 221 to be located to the bottoms of the connecting surfaces 610 of the plurality of the fastening blocks 61 of the insulating housing 6. The protecting plane 612 is connected between two rear ends of the two inclining surfaces 611. Each rounded corner 613 is formed between one inclining surface 611 and one side of the protecting plane 612. The two rounded corners 613 are arched outward. The protecting planes 612 of the plurality of the fastening blocks 61 are used for shaping the plurality of the fastening blocks 61 easily to prevent causing a burr of each fastening block 61. The protecting plane 612 is used for preventing a short shot problem of the insulating housing 6. The two rounded corners 613 are used for guiding the bottom ends of the lower extending portions 225 of the plurality of the lower terminals 221 to be positioned in the plurality of the fastening slots 62. The two rounded corners 613 make the lower soldering portions 226 and the reflecting portions 228 of the plurality of the lower terminals 221 exposed to the bottoms of the connecting surfaces 610 of the plurality of the fastening blocks 61 easily.

Referring to FIG. 1 to FIG. 10, the electrical connector 100 includes the terminal assembly 2 fastened in the insulation body 1. The insulation body 1 together with the terminal assembly 2 is received in the insulating housing 6. The terminal assembly 2 includes the upper terminal assembly 21 and the lower terminal assembly 22. The terminal assembly 2 includes a base portion 102, and a plurality of the terminals 103 fastened in the base portion 102. The plurality of the terminals 103 include the plurality of the upper terminals 211 and the plurality of the lower terminals 221. Each terminal 103 has a fastening portion 104. A front end of the fastening portion 104 extends frontward to form a contacting portion 105. A rear end of the fastening portion 104 is bent downward to form a bending portion 106. A bottom end of the bending portion 106 extends downward to form an extending portion 107. A bottom end of the extending portion 107 is bent longitudinally and extends longitudinally to form a soldering portion 108. The base portion 102 has a main body 111. A rear end of the main body 111 extends downward to form the surrounding portion 2124 of the base portion 102. The extending portions 107 of the plurality of the terminals 103 are fastened in the surrounding portion 2124, and the extending portions 107 of the plurality of the terminals 103 are surrounded by the surrounding portion 2124. The extending portions 107 of the plurality of the terminals 103 are longitudinally arranged in a front row and a rear row. The soldering portions 108 of the plurality of the terminals 103 project beyond the bottom surface of the surrounding portion 2124. An outer surface of a junction between the rear end of the main body 111 and the top end of the surrounding portion 2124 is recessed inward to form the fastening groove 2125 of the base portion 102. The bending portions 106 of the plurality of the terminals 103 are exposed out of the base portion 102 from the fastening groove 2125.

The base portion 102 includes the upper base portion 212 and the lower base portion 222. The fastening portion 104 includes the upper fastening portion 213 and the lower fastening portion 223. The contacting portion 105 includes the upper contacting portion 214 and the lower contacting portion 224. The bending portion 106 includes the upper bending portion 215 and the lower bending portion 227. The extending portion 107 includes the upper extending portion 216 and the lower extending portion 225. The soldering portion 108 includes the upper soldering portion 217 and the lower soldering portion 226. The main body 111 includes the upper main body 2121 and the lower main body 2221.

The contacting portions 105 of the plurality of the terminals 103 are exposed to an outer surface of a front end of the base portion 102. The inclining surfaces 611 and the protecting planes 612 of the plurality of the fastening blocks 61 guide the bottom ends of the extending portions 107 of the plurality of the terminals 103 which are arranged in the front row to be positioned in the plurality of the fastening slots 62. The bottom end of the extending portion 107 of each terminal 103 is buckled between the two connecting surfaces 610 of the two adjacent fastening blocks 61. The inclining surfaces 611 and the protecting planes 612 of the plurality of the fastening blocks 61 guide the soldering portions 108 of the plurality of the terminals 103 to be located to the bottoms of the connecting surfaces 610 of the plurality of the fastening blocks 61 of the insulating housing 6. Several portions of the top end and a bottom end of the surrounding portion 2124 of the base portion 102 vertically protrude outward to form a plurality of protruding portions 2126 of the base portion 102. The plurality of the protruding portions 2126 cover outer surfaces of the extending portions 107 and the soldering portions 108 of the plurality of the terminals 103.

As described above, the electrical connector 100 has an innovative structure design, the upper bending portions 215 of the plurality of the upper terminals 211 are exposed out of the upper base portion 212 from the fastening groove 2125 of the upper base portion 212. When the upper base portion 212 is molded to the plurality of the upper terminals 211, and the insulation body 1 is molded to the upper terminal assembly 21 in the high speed injection molding process, the fastening groove 2125 of the upper base portion 212 prevents the plurality of the upper terminals 211 from causing the deformation and the displacement of the plurality of the upper terminals 211. The plurality of the protruding portions 2126 of the upper base portion 212 cover the outer surfaces of the upper extending portions 216 and the upper soldering portions 217 of the plurality of the upper terminals 211, so that the size stability of the plurality of the upper terminals 211 and the assembling accuracy of the plurality of the upper terminals 211 are ensured. Furthermore, the rear ends of the two connecting surfaces 610 of each fastening block 61 slantwise extend rearward and inward to form the two inclining surfaces 611, the protecting plane 612 is connected between the two rear ends of the two inclining surfaces 611, so the protecting planes 612 of the plurality of the fastening blocks 61 are used for shaping the plurality of the fastening blocks 61 easily to prevent causing the burr of each fastening block 61, and the protecting plane 612 is used for preventing the short shot problem of the insulating housing 6. In addition, the lower extending portions 225 and the lower soldering portions 226 of the plurality of the lower terminals 221 are inclined frontward, each lower terminal 221 is preloaded, when the lower terminal assembly 22 is assembled with the insulating housing 6, the bottom ends of the lower extending portions 225 of the plurality of the lower terminals 221 are easily inserted into the plurality of the fastening slots 62 of the insulating housing 6, and the lower soldering portions 226 and the reflecting portions 228 of the plurality of the lower terminals 221 are easily exposed to the bottoms of the plurality of the fastening slots 62 for improving the assembling accuracy of the plurality of the upper terminals 211. As a result, the electrical connector 100 has the insulating housing 6 without the burr, a higher assembling accuracy of the soldering portion 108 of the terminal 103 and a stable size of the terminal 103, and prevents a short shot problem of the insulating housing 6.

What is claimed is:

1. An electrical connector, comprising:
an insulating housing having a plurality of fastening blocks and a plurality of fastening slots, several portions of a lower end of a rear surface of the insulating housing extending rearward to form the plurality of the fastening blocks, each fastening slot being formed between two adjacent fastening blocks, each fastening block having two connecting surfaces, two inclining surfaces and a protecting plane, two fronts of two opposite sides of each fastening block extending rearward to form the two connecting surfaces, the connecting surfaces of the plurality of the fastening blocks being connected to the plurality of the fastening slots, rear ends of the two connecting surfaces of each fastening block slantwise extending rearward and inward to form the two inclining surfaces, the protecting plane being connected between two rear ends of the two inclining surfaces;
an insulation body fastened in the insulating housing;
an upper terminal assembly fastened in an upper portion of the insulation body, the upper terminal assembly including a plurality of upper terminals and an upper base portion, the plurality of the upper terminals being fastened in the upper base portion, each upper terminal having an upper fastening portion, a front end of the upper fastening portion extending frontward to form an upper contacting portion, a rear end of the upper fastening portion being bent downward to form an upper bending portion, a bottom end of the upper bending portion extending downward to form an upper extending portion, a bottom end of the upper extending portion being bent rearward to form an upper soldering portion, a rear end of the upper base portion extending downward to form a surrounding portion, several portions of a top end and a bottom end of the surrounding portion vertically protruding outward to form a plurality of protruding portions, the upper contacting portions of the plurality of the upper terminals being exposed to a top surface of a front end of the upper base portion, the upper extending portions of the plurality of the upper terminals being fastened in the surrounding portion, and the upper extending portions of the plurality of the upper terminals being surrounded by the surrounding portion, the plurality of the protruding portions covering outer surfaces of the upper extending portions and the upper soldering portions of the plurality of the upper terminals; and
a lower terminal assembly fastened in a lower portion of the insulation body, the upper terminal assembly and the lower terminal assembly being disposed opposite to each other, the lower terminal assembly including a plurality of lower terminals and a lower base portion, the plurality of the lower terminals being fastened in the lower base portion, each lower terminal being disposed between the two adjacent fastening blocks, each lower terminal having a lower fastening portion, a front end of the lower fastening portion extending frontward to form a lower contacting portion, a rear end of the lower fastening portion being bent downward to form a lower bending portion, a bottom end of the lower bending portion extending downward to form a lower extending portion, a bottom end of the lower extending portion being bent frontward to form a reflecting portion, a front end of the reflecting portion extending frontward to form a lower soldering portion, the lower contacting portions of the plurality of the lower terminals being exposed to a bottom surface of a front end of the lower base portion, the inclining surfaces of the plurality of the fastening blocks guiding the bottom ends of the lower extending portions of the plurality of the lower terminals to be positioned in the plurality of the fastening slots, the bottom end of the lower extending portion of each lower terminal being buckled between the two connecting surfaces of the two adjacent fastening blocks, the inclining surfaces of the plurality of the fastening blocks guiding the lower soldering portions and the reflecting portions of the plurality of the lower terminals to be located to bottoms of the connecting surfaces of the plurality of the fastening blocks of the insulating housing.

2. The electrical connector as claimed in claim 1, wherein an angle between an inner surface of the lower fastening portion and an inner surface of the lower extending portion which are located to two ends of the lower bending portion of each lower terminal is ranged from eighty-seven degrees to eighty-eight point five degrees.

3. The electrical connector as claimed in claim 1, wherein an angle between an inner surface of the lower extending portion and an inner surface of the lower soldering portion which are located to two ends of the lower reflecting portion of each lower terminal is ranged from eighty-nine degrees to ninety degrees.

4. The electrical connector as claimed in claim 1, wherein the upper base portion has an upper main body, a rear end of the upper main body extends downward to form the surrounding portion, an outer surface of a junction between the rear end of the upper main body and the top end of the surrounding portion is recessed inward to form a fastening groove, outer surfaces of the upper bending portions of the plurality of the upper terminals are exposed out of the upper base portion from the fastening groove.

5. The electrical connector as claimed in claim 1, wherein the lower extending portions of the plurality of the lower terminals are corresponding to the upper extending portions of the plurality of the upper terminals, the lower soldering portions of the plurality of the lower terminals are corresponding to the upper soldering portions of the plurality of the upper terminals, an extending direction of the lower soldering portion is opposite to an extending direction of the upper soldering portion.

6. The electrical connector as claimed in claim 1, wherein the plurality of the fastening blocks are arranged in a comb shape.

7. An electrical connector, comprising:
an insulating housing having a plurality of fastening blocks and a plurality of fastening slots, several portions of a lower end of a rear surface of the insulating housing extending rearward to form the plurality of the fastening blocks, each fastening slot being formed between two adjacent fastening blocks, each fastening block having two connecting surfaces, two inclining surfaces and a protecting plane, two fronts of two opposite sides of each fastening block extending rearward to form the two connecting surfaces, the connecting surfaces of the plurality of the fastening blocks being connected to the plurality of the fastening slots, rear ends of the two connecting surfaces of each fastening block slantwise extending rearward and inward to form the two inclining surfaces, the protecting plane being connected between two rear ends of the two inclining surfaces;
an insulation body fastened in the insulating housing; and
a terminal assembly fastened in the insulation body, the insulation body together with the terminal assembly being received in the insulating housing, the terminal assembly including a base portion, and a plurality of terminals fastened in the base portion, each terminal having a fastening portion, a front end of the fastening portion extending frontward to form a contacting portion, a rear end of the fastening portion being bent downward to form a bending portion, a bottom end of the bending portion extending downward to form an extending portion, a bottom end of the extending portion being bent longitudinally and extending longitudinally to form a soldering portion, the base portion having a main body, a rear end of the main body extending downward to form a surrounding portion, the extending portions of the plurality of the terminals being fastened in the surrounding portion, and the extending portions of the plurality of the terminals being surrounded by the surrounding portion, the extending portions of the plurality of the terminals being longitudinally arranged in a front row and a rear row, the soldering portions of the plurality of the terminals projecting beyond a bottom surface of the surrounding portion, an outer surface of a junction between the rear end of the main body and a top end of the surrounding portion being recessed inward to form a fastening groove, the bending portions of the plurality of the terminals being exposed out of the base portion from the fastening groove;
wherein the contacting portions of the plurality of the terminals are exposed to an outer surface of a front end of the base portion, the inclining surfaces and the protecting planes of the plurality of the fastening blocks guide the bottom ends of the extending portions of the plurality of the terminals which are arranged in the front row to be positioned in the plurality of the fastening slots, the bottom end of the extending portion of each terminal is buckled between the two connecting surfaces of the two adjacent fastening blocks, the inclining surfaces and the protecting planes of the plurality of the fastening blocks guide the soldering portions of the plurality of the terminals to be located to bottoms of the connecting surfaces of the plurality of the fastening blocks of the insulating housing.

8. The electrical connector as claimed in claim 7, wherein several portions of the top end and a bottom end of the surrounding portion vertically protrude outward to form a plurality of protruding portions, the plurality of the protruding portions cover outer surfaces of the extending portions and the soldering portions of the plurality of the terminals.

9. An electrical connector, comprising:
an insulating housing having a plurality of fastening slots, several portions of a lower end of a rear surface of the insulating housing extending rearward to form a plurality of fastening blocks, each fastening slot being formed between two adjacent fastening blocks, each fastening block having two connecting surfaces, two inclining surfaces, a protecting plane and two rounded corners, two fronts of two opposite sides of each fastening block extending rearward to form the two connecting surfaces, the connecting surfaces of the plurality of the fastening blocks being connected to the plurality of the fastening slots, rear ends of the two connecting surfaces of each fastening block slantwise extending rearward and inward to form the two inclining surfaces, the protecting plane being connected between two rear ends of the two inclining surfaces, each rounded corner being formed between one inclining surface and one side of the protecting plane;
an insulation body fastened in the insulating housing;
an upper terminal assembly fastened in an upper portion of the insulation body, the upper terminal assembly including a plurality of upper terminals and an upper base portion, the plurality of the upper terminals being fastened in the upper base portion, each upper terminal having an upper fastening portion, a front end of the upper fastening portion extending frontward to form an upper contacting portion, a rear end of the upper fastening portion being bent downward to form an upper bending portion, a bottom end of the upper bending portion extending downward to form an upper extending portion, a bottom end of the upper extending portion being bent rearward to form an upper soldering portion, a rear end of the upper base portion extending downward to form a surrounding portion, several portions of a top end and a bottom end of the surrounding portion vertically protruding outward to form a plurality of protruding portions, the upper contacting portions of the plurality of the upper terminals being exposed to a top surface of a front end of the upper base portion, the upper extending portions of the plurality of the upper terminals being fastened in the surrounding portion, the plurality of the protruding portions covering outer surfaces of the upper extending portions and the upper soldering portions of the plurality of the upper terminals; and
a lower terminal assembly fastened in a lower portion of the insulation body, the upper terminal assembly and the lower terminal assembly being disposed opposite to each other, the lower terminal assembly including a plurality of lower terminals and a lower base portion, the plurality of the lower terminals being fastened in the lower base portion, each lower terminal being disposed between the two adjacent fastening blocks, each lower terminal having a lower fastening portion, a front end of the lower fastening portion extending frontward to form a lower contacting portion, a rear end of the lower fastening portion being bent downward to form a lower bending portion, a bottom end of the lower bending portion extending downward to form a lower extending portion, a bottom end of the lower extending portion being bent frontward to form a reflecting portion, a front end of the reflecting portion extending frontward to form a lower soldering portion, the lower contacting portions of the plurality of the lower terminals being exposed to a bottom surface of a front end of the lower base portion, the inclining surfaces of the plurality of the fastening blocks guiding the bottom ends of the lower extending portions of the plurality of the lower terminals to be positioned in the plurality of the fastening slots, the bottom end of the lower extending portion of each lower terminal being buckled between the two connecting surfaces of the two adjacent fastening blocks, the inclining surfaces of the plurality of the fastening blocks guiding the lower soldering portions and the reflecting portions of the plurality of the lower terminals to be located to bottoms of the connecting surfaces of the plurality of the fastening blocks of the insulating housing.
